(19) United States
(12) Patent Application Publication
(10) Pub. No.: US 2004/0254957 A1
(43) Pub. Date: Dec. 16, 2004

(54) Method and a system for modeling user preferences

(75) Inventors: Heikki Hyotyniemi, Helsinki (FI); Ferenc Dosa Racz, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/462,210

(22) Filed: Jun. 13, 2003

(51) Int. Cl. G06F 17/00

(52) U.S. Cl. 707/104.1

(57) ABSTRACT

A method and a system for modeling user preferences in a high-dimensional data space (106) wherein data entities are presented as vectors the elements of which are characteristic features thereof, the data entities being clustered into a number of categories, and a set of latent vectors (110, 114) specifying directions in the data space (106). The model is updated on the basis of user feedback; if the feedback (120, 122) concerning a data entity in the data space is positive, the model adapts towards the entity, otherwise away from it. Latent vectors (110, 114) that constitute a set of global mood components are weighted with user-specific weighting factors in order to locate a user-specific mood center in the data space (106) in relation to the current category center (108, 112). The model may be exploited in a web radio computer application transmitting personalized program to the users.

### FIELD OF THE INVENTION

The present invention relates generally to a method and a system for representing a multi-dimensional data space by subspaces and component vectors. Particularly the invention concerns services with a plurality of users, and techniques for modeling different users' preferences including mood and behaviour on the basis of gathered information. The model may be utilized in generating both user specific and average profiles for a web radio computer application exploiting listener data in program planning, for example.

### BACKGROUND OF THE INVENTION

Personalization is one of the key aspects in providing modern services as people's preferences seldom match perfectly with each other and “average user” driven solutions are typically more or less inadequate depending on the case. Furthermore, many contemporary services are either so complex or otherwise wide-ranging and sophisticated that without a possibility to modify the typical usage environment to fit the user's needs and habits, the adoption of such programs slows down considerably or does not take place at all. A traditional solution is to allow the users to define a service related user profile of their own in order to enable the service to better adapt to the user's wishes about the service details. However, these profiles are often fixed or only minor adaptation is possible.

Taking an Internet based radio station as an example, different people hardly favour exactly similar kinds of music and thus a need arises for some user specific adaptation. In a general sense different views exist for providing some personalization to the end user. MongoMusic (Internet music company) classifies pieces of music according to their features; the listener may then select the genre he is keen on. On the other hand, more profound approaches allow the user to explicitly affect his preferences. This has been made possible by creating personal profiles describing the users' listening habits. A user first manually enters a profile as he starts using the service. For instance, in an application called LaunchCast (customizable Internet radio station) the user profiles can be further utilized for collaborative filtering in order to propose new songs to a user whose profile matches some other users' data. Furthermore, in some systems the profiles may even be adaptive with the result that the user's actions modify the model parameters. However, little has been analyzed concerning whether knowledge about the user's average behaviour actually captures the essence of the listening habits. Moreover, the profiles have been rather crude and static in comparison to ever-changing real life scenarios.

### SUMMARY OF THE INVENTION

The object of the present invention is to provide adaptive means for modeling user preferences in a multi-dimensional data space by utilizing a combination of clustered linear subspaces and a set of vectors representing the independent components within the data clusters. The object is achieved with a method and a system enabling the adaptive modeling with reasonable computational requirements but still sufficient complexity and accuracy in most occasions.

The invention offers several advantages over the prior art in providing both high and low level characterizations of the user preferences at the same time. In addition, a global model of latent vectors, i.e. so-called mood components, and a set of average user category prototypes are generated automatically for further statistical analysis and to be used in collaborative filtering as well. The flexible but still sophisticated model can be easily updated later by adding new data vectors and parameters, or by re-adjusting the preferred level of details, e.g. the number of possible latent vectors. The model so obtained is truly dynamic and, in addition, serves irregular users as well because also other people's actions affect the model parameters establishing a core frame for fully personal adaptation.

According to the invention, a method for modeling user preferences in a multi-dimensional data space wherein data entities are presented as vectors the elements of which are characteristic of features thereof, the data entities being clustered into a number of categories, a set of latent vectors specifying directions in the data space, comprises the steps of

defining an initial set of at least two latent vectors,

defining an initial category center for each category of data,

obtaining feedback concerning a data entity related to one of the categories,

adjusting the category center of the category on the basis of obtained feedback,

adjusting latent vectors on the basis of said obtained feedback, and

adjusting a set of weighting factors on the basis of obtained feedback in order to weight a set of latent vectors with the adjusted weighting factors in order to determine the user's present preferences in relation to said data space.

In another aspect of the invention a system comprising processing means and memory means for modeling user preferences in a multi-dimensional data space wherein data entities are presented as vectors the elements of which are characteristic of features thereof, the data entities being clustered into a number of categories, a set of latent vectors specifying directions in the data space, further comprises means for obtaining feedback concerning a data entity related to one of the categories;

the system is arranged to define an initial set of latent vectors and an initial category center for each category of data, to adjust the category center of the category on the basis of the obtained feedback, to adjust the latent vectors on the basis of the obtained feedback, and to adjust a set of weighting factors on the basis of the obtained feedback in order to weight a set of latent vectors with said adjusted weighting factors in order to determine the user's present preferences relative to said data space.

In a further aspect of the invention, a server comprising processing means and memory means for modeling user preferences in a multi-dimensional data space wherein data entities are presented as vectors the elements of which are characteristic of features thereof, the data entities being clustered into a number of categories, a set of latent vectors specifying directions in the data space, further comprises data transfer means for receiving feedback concerning a data entity related to one of the categories;

the server is arranged to define an initial set of latent vectors and an initial category center for each category of data, to adjust the category center of the category on the basis of the obtained feedback, to adjust the latent vectors on the basis of the obtained feedback, and to adjust a set of weighting factors on the basis of the obtained feedback in order to weight a set of latent vectors with the adjusted weighting factors in order to determine the user's present preferences relative to said data space.

In a further aspect of the invention, an electronic device for interfacing a user with a server capable of modeling user preferences in a multi-dimensional data space wherein data entities are presented as vectors the elements of which are characteristic of features thereof, the data entities being clustered into a number of categories, a set of latent vectors specifying directions in the data space, comprises processing means and memory means for processing and storing data, user interface for receiving feedback, and data transfer means for sending the feedback or a derivative thereof to the server and receiving data from the server, the data received being selected in accordance with the feedback sent, the feedback concerning a data entity related to one of the categories and affecting at least one of the following user preference model parameters in the server: category center, latent vector, weighting factor for latent vector.

The terms “preferences” and “mood” should be interpreted broadly herein and they generally refer to the user's personality and/or behavioural characterization in a mathematical and statistical sense; modeling of mental aspects can be considered reached indirectly via these explicit formulations. Correspondingly, a current “mood center” is the location in the data space in which the user is supposed to reside according to the category selected and feedback obtained. The mood center location can be utilized in finding the data entities that match the user best at that moment from a larger group of data.

The term “latent vector” refers to a basic component for defining directions in the data space. Latent vectors can also be called as independent mood components that are weighted by user/category-specific weighting factors in order to find the aforesaid mood center of the user. In the described embodiment of the invention the latent vectors are adjusted by utilizing especially the Kohonen learning rule (Kohonen Teuvo, Self-organizing Maps, Heidelberg, Germany 1995, Springer-Verlag, Series in Information Sciences, Vol. 30) but also other possibilities exist. For example, a well-known procedure of Principal component analysis (PCA) involves a mathematical method that transforms a number of correlated variables into a smaller number of uncorrelated variables called principal components. These principal components could be used to define latent vectors, respectively.

In one embodiment of the invention, the proposed modeling technique is utilized in a personal net, especially web (WWW, World Wide Web), radio system “MyChannel” fetching music from the server, classifying it according to user-specific criteria and giving out a consistent stream of the user's favourite program. In this embodiment, finding preferences of a single user is performed by constructing a user model comprising both so-called category vectors defining data clusters, and latent (mood) vectors being independent components within the data clusters, for representing the high-dimensional data space originally spanned by feature vectors reflecting the properties of various program entities the radio sends out. In practice, the aforesaid user model is generated by fine-tuning a more generic average user model according to the feedback from the user.

### BRIEF DESCRIPTION OF THE DRAWINGS

Hereinafter the invention is described in more detail by reference to the attached drawings, wherein

FIG. 1 illustrates an overall concept of the invention and its first embodiment, in which a personal radio software located in the user's terminal includes a user interface with channel selector and voting buttons for controlling the radio software in the server producing the program stream according to the user preferences.

FIG. 2 depicts a schematic view of a temporal division of program types within a period of two hours program time.

FIG. 3A is a high-level flow diagram disclosing one option for performing the proposed method of modeling the user preferences.

FIG. 3B is a more detailed flow diagram of the actual adaptation of latent vectors and weighting factors presented only as single entities in diagram of FIG. 3A.

FIG. 4 is an exemplary block diagram of an electronic device like a pc computer or a mobile terminal and internals thereof, capable of executing the method of the invention.

### DETAILED DESCRIPTION OF THE PREFERRED EMBODIMENT OF THE INVENTION

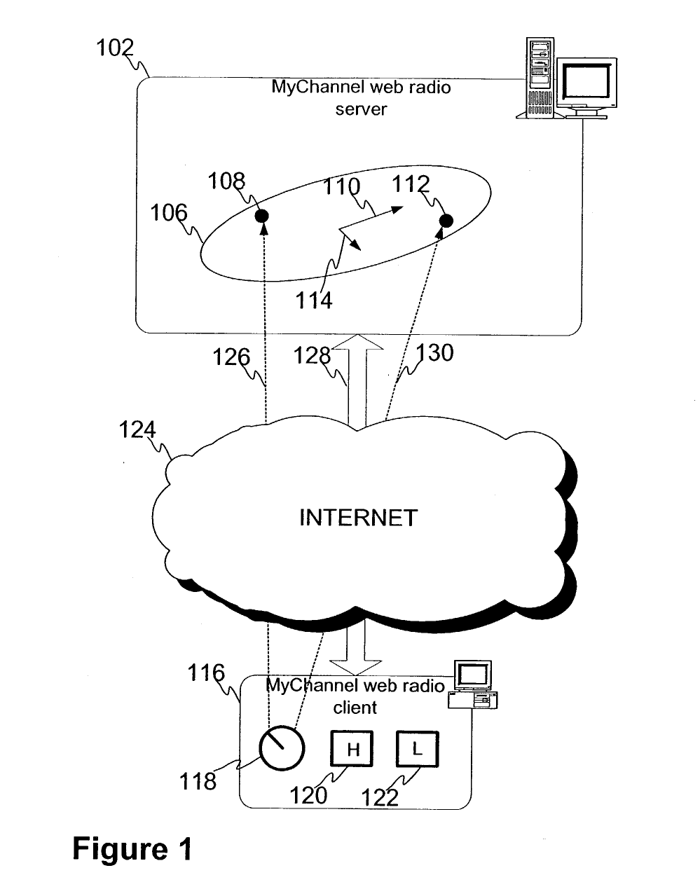

FIG. 1 discloses, by way of example, basic principles of the invention via its first embodiment including a server 102 (e.g. pc) for delivering a program stream in accordance with the user model, and a client software in a terminal device 116 such as a pc computer, PDA (Personal Digital Assistant) or advanced mobile terminal functionally connected to the server 102 over the Internet 124 for receiving and decoding the personalized program stream. Two-way data connection 128 passes data between the server 102 and the terminal 116 including the actual program stream and control parameters such as program selection 118 or user feedback information (or a derivative thereof) originated from pressing voting buttons Hate 120 and Love 122 placed in the net radio UI (User Interface) to indicate like/dislike of the current program. Entity 106 represents a feature space including two mood centers (“mood channels”) 108 and 112 for e.g. “sad” and “ecstatic” mood, respectively. The user may select his mood channel via the program selection switch 118 resulting in change 126, 130 in the selected feature cluster, which settles itself around the mood center and is determined by the mood axes. Two vectors 110, 114 are illustrative two-dimensional projections of corresponding latent vectors, independent components describing mood axes (in practice, directions) in the feature space.

The program entities are presented as high-dimensional data vectors that characterize the entities' properties; individual properties are called features, and features relating to a certain program entity constitute a d dimensional feature vector ƒ, wherein d is the number of features. User preferences are to be modelled by finding a structure among feature vectors that seems to fancy the user. Adopting terminology from cognitive science, the mental categories are modified by attributes for fine-tuning. For example, musical genres can be seen as categories, and stylistic factors may be seen as attributes. In a statistical sense, mental level concepts are reflected in the data space spanned by the feature vectors as clusters with latent vectors determining subspace directions. The assumption is made that latent vectors to be searched are “independent components” within the data clusters; this assumption about statistical independence (“sparsity”) gives tools for extracting them. The same approach has given good results in other, at least partially cognitive, modeling tasks.

When a program entity is matched against the user profile, the matching error can be used to predict whether the user would like the program or not. A new user starts with a generic average user profile that then starts adapting according to the feedback by the user. However, practical problems may arise when this kind of sophisticated model structure is adopted; for an average and maybe not-so-active listener the gathered feedback is not sufficient for finding truly personal latent structures as the model with both the average feature values and the fine-tuning latent vectors has much more degrees of freedom than a simple average feature model. Therefore, a pragmatic simplification is taken into use: it is assumed that the latent “mood structure” is invariant within groups of listeners. That is, only one set of latent vectors Φᵢ, where 1≧i≧n, is constructed. The user's moods vary around their personal category cluster centers θ_{ν} in a predictable manner. Thus, it is assumed that among different people, even though their average listening habits probably vary, there are some underlying generic mood components. Interviews with people have revealed that many like to think of their moods as discrete entities rather than extremes along a continuum. This fact is implemented in the system so that the user's mood centers have some fixed (but adaptive) representation in the subspace determined by the mood axes. By reference to FIG. 1 the user can immediately switch between moods 108, 112 by twiddling the “mood channel” selector 118. On the other hand, pressing of the feedback buttons 120, 122 causes the model to adapt the user's average preference vector and mood representation; if the response was “love” 122, the model is adapted towards f, otherwise 120 away from it.

In this particular embodiment the user profiles, etc., do not contain all the necessary information for constructing a reasonable flow of radio program. The user model comprises only static information whereas the dynamic allocation of program entities has to be carried out separately. The rule-based software that takes care of the radio program flow is called a selector.

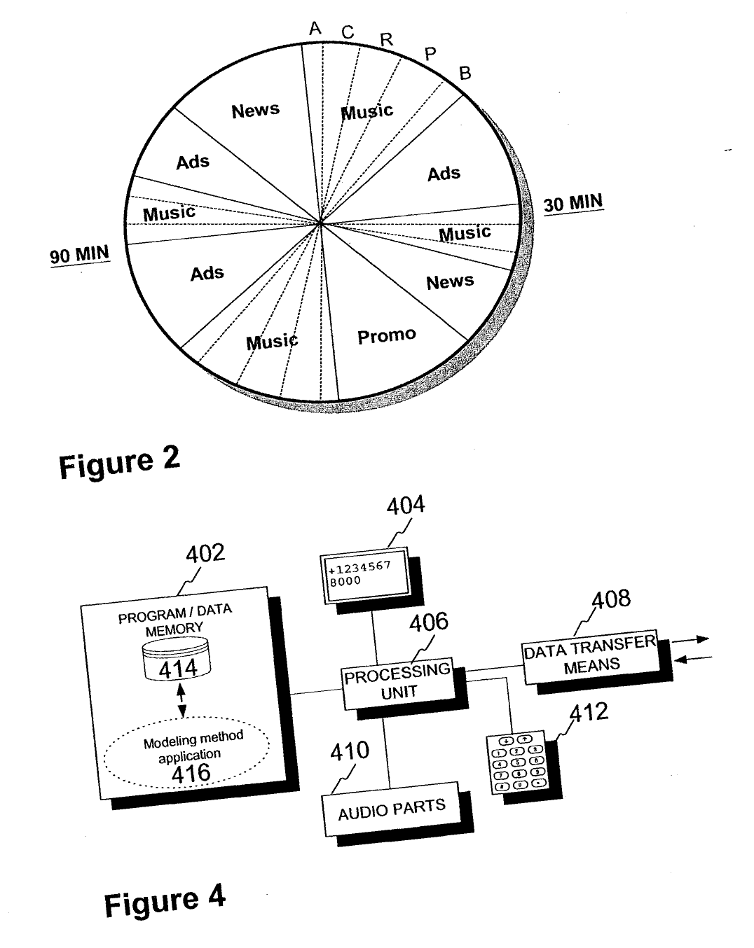

As illustrated in FIG. 2, musical categories A, B, C, R and P and other program items are spread within each two hours period in a pre-programmed order. A piece of music is selected among all alternatives that fulfil the selector rules according to its probability ranking calculated using the static model determined by the user's preferences. Typically the selector rules determine that the same pieces of music are not played at the same time during different days, music from the same artist is not played in a row, same pieces are not played too often etc. Furthermore, the “mode” of the music (happy, sad, etc.) may be varied cyclically but advantageously still around the user-specific preference. There exist various techniques to implement a selector but as it already is established technology exploited by radio channels, it is not analyzed more deeply hereinafter.

Feature vectors f that characterize program entities like pieces of music consist of two parts. First, so-called “qualitative”, part includes (binary) entries for different artists, pieces of music etc. All names as being mutually incommeasurable must be presented by a unique entry in the vector resulting in sparse coding of vectors as entities since such are so seldom employed. A second part holds entries that apply to all pieces of music; the part is thus densely coded. An expert at the radio station places every piece of music into one of the following categories: A hot hits, B established, C new emerging, R old, P evergreen so that only one of the corresponding entries is “1”. Additionally, the following entries are explicitly defined for each piece:

Mode: numeric measure along the axis happy-sad

Energy: numeric measure from peaceful to energetic

Tempo: qualitative (symbolic) speed code (e.g. “medium”)

Texture: numeric measure for the musical structure

Role: symbolic information whether the tune can be associated with female, group, instrumental etc

Style: symbolic code for musical style (I=instrumental etc.)

Time: when to be played—“morning” etc.

Era: alternatives 2000/1990/1980/1970

As will be evident, the qualitative variables are to be transformed into a numeric form. For example, “medium” is probably 3 on the axis from 1 to 5 (or 0.5 if 0-1 scale) Symbolic variables (rock/latino etc) have to be given an own entry in the parameter vector (“1” if applies, “0” otherwise).

In addition to code the properties of program entities, the user data is also stored in vectors g containing demographic profiles. For example, the following entries can be included:

Age group

Sex

Residence

Marital status

Income level

Education.

The user profile of the user ν, which is to be stored separately for each registered end-user, includes the following vectors:

category prototype vectors θ_{ν}(1) to θ_{ν}(N), where N is the number of categories, comprises demographic and program data entity specific information and can be formulated by

$${θ}_{v} ( i ) = ( \begin{matrix}{g}_{v} \\ {f}_{v} ( i )\end{matrix} )$$

wherein ƒ_{ν} is sparse coded; elements are non-zero only if the corresponding entries in a relevance vector ρ_{ν} are non-zero.

Relevance vector ρ_{ν} comprises one entry for all non-zero elements in ƒ vectors (sparse coded).

Personal moods are represented as weighting vectors ω_{ν}(mood), the different elements of which weight the corresponding global latent mood vectors Φᵢ.

Accordingly, Ω is the matrix of ω's for different categories. In practise, also same weighting factors could be used in several categories if the relative position of a certain user were considered constant in relation to the global latent vectors despite of the current category. This approach would result storage space savings at the cost of modelling accuracy.

In addition, the average listener model (a single one for the whole system) comprises:

matrix of average user category prototypes θ=E{θ_{ν}}, comprising a prototype vector for each category type,

latent vectors Φ₁ to Φₙ, first properly initialized upon e.g. a service start-up (in a (pseudo-)random manner or by utilizing e.g. principal component analysis/SOM) to be updated later during the adaptation, and optionally

weighting vector matrix Ω comprising average weighting vectors.

The category vectors include a number of demographic entries describing the end user and feature entries standing for the piece of music. Latent vectors can be interpreted similarly. Naturally, demographic information g_{ν} cannot be adapted. Whenever a new user enters the system, his initial category center prototypes and optionally also weighting vectors are taken from other users: θ_{ν}=θ and Ω=Ω, except the demographic features which are personal of course. Later, upon a session start-up, the user's current location in the categories can be matched with the user's category prototypes resulting that the corresponding weighting vectors are zeroed for each session.

The actual model adaptation algorithm is explained hereinafter.

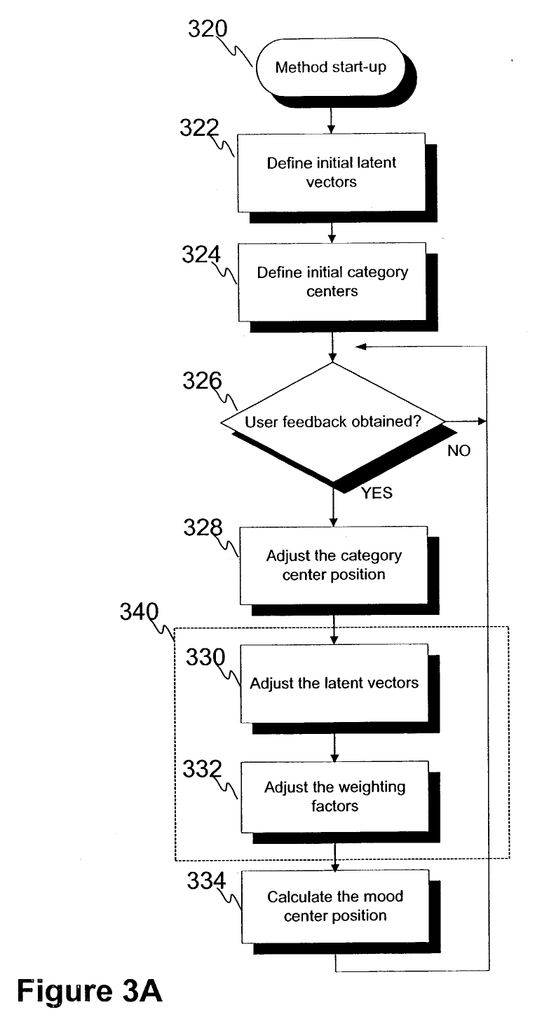

FIG. 3A discloses a high-level flow chart of the algorithm. After method start-up 320 which occurs, for example, in connection with the overall service establishment phase, the preferred number of initial latent vectors (e.g. 10) and category centers (e.g. N=5, see, for example, five musical categories in FIG. 2 if other program types are not to be modeled with the method) are defined in steps 322 and 324, correspondingly. After these stages the system is ready to act on the basis on gathered feedback 326 from the users. However, in between the illustrated steps 324 and 326 one or more users have joined the service, which may be located in the server connected to the Internet, possibly defined/altered their personal settings and selected a preferred channel for receiving the service data (e.g. a piece of music) corresponding to the mood of the moment, but said events are omitted from the flow chart as being easy to understand and relatively straightforward to put in practice by a skilled person. Data exchange relating to service registration etc may be performed via standard messaging principles over the Internet and do not belong to the scope of the actual invention either. The user feedback may be as simple as a one bit data field indicating ‘hate’ (0) or ‘love’ (1) of the received data, or alternatively a more complex and, at the same time, more descriptive variable with wider range, e.g. 0-8. The user has entered his opinion to the client system by e.g. pressing certain buttons on his user interface such as a keyboard, and the client software has forwarded the feedback data to the server. By the feedback, the system adjusts the category center positions 328 and latent vectors 330 as explained later. Also user-specific (and advantageously category specific) weighting factors are adjusted 332. Finally, a new mood center position is calculated to the user 334 in order to facilitate suggesting next, even more appropriate, data entity for exploitation. The method restarts from step 326 where new feedback is waited for, for the purpose of revising the model. Connective step 340 including steps 330 and 332 is illustrated in FIG. 3B and described more thoroughly later in the text.

Considering the details of the presented high-level method, with reference to the scenario of FIG. 1 and the flow chart of FIG. 3A, the models are adapted as a response to the user's vote indicated by pressing of hate 120 or love 122 buttons whereupon the following actions take place (γ's are adaptation parameters having small adjustable numerical values):

A) Adjustment of Adaptation Parameters

According to the rate of love or hate, the adaptation parameters are modified:

γ←|α|γ_{L}+(1−|α|)γ_{H}

if α<0, let ƒ←2ƒ_{ν}−ƒ,

where α is the adaptation step length reflecting “hate” 120 or “love” 122, −1≦α≦1, negative values meaning dislike.

B) Initialization of Variables

First, a user specific category center is updated based on the difference between the category center vector and current feature vector. Next, the average model is altered as well before calculating the residual φ for latent vector adaptation:

$$\begin{matrix}\begin{matrix}\begin{matrix}{f}_{v} ← {f}_{v} + γ ( f - {f}_{v} ) \\ \overline{θ} ← \overline{θ} + {γ}_{β} ( ( \frac{{g}_{v}}{f} ) - \overline{θ} )\end{matrix} \\ ϕ = ( \frac{{g}_{v}}{f} ) - ( \frac{\overline{g}}{{f}_{v}} ) .\end{matrix} \\ Δ {ω}_{i} ← 0 for 1 \leq i \leq n\end{matrix}$$

C) Adaptation of the Latent Vectors

The iteration is a modification of the above-mentioned Kohonen learning law and proceeds as follows with reference to the flow diagram of FIG. 3B:

1. Latent variable with index c having the best correlation (positive or negative) with the target residual φ is selected, step 342:

c=arg max {|Φⱼ^{T}φ|}.

2. A Kohonen type learning algorithm is applied for all j, after which the vectors are normalized, step 344:

Φⱼ←Φⱼ+γ_{K}h(j, c)·|Φ_{C}^{T}φ|·(sign(Φ_{c}^{T}φ)·φ−Φⱼ).

The neighborhood effect h can be updated after each algorithm run by

$$h ( {j}_{1} , {j}_{2} ) = {ⅇ}^{- \frac{1}{2} δ ( {j}_{1} , {j}_{2} ) / {δ}_{n}^{2}} ,$$

where the grid distance δ is simplest to calculate with a linear grid: δ(j₁,j₂)=|j₁−j₂|. δₙ is the parameter defining “neighborhood width” starting from the nominal width δ=1,0 and after an infinite (in practise, a large) number of rounds ending at δ_{∞}=0,1, for example. γ_{K} parameter (for example: 0,05) defines the learning rate of the algorithm, so-called “Kohonen adaptation rate”.

Kohonen originally developed his learning rule and the concept of SOM (Self-Organizing Map) to nonlinearly map a signal of higher dimension to a presentation of lower dimension still preserving the original topological relationships in the input space. On a conceptual level, areas in the input space are represented by certain reference points (PEs, Processing Elements) in the output space. As a response to an input a winning PE is selected by preferred criteria (best match). This criteria typically includes distance metric, often being in practice a simple Euclidean one. Differing from many other learning models, all the reference points are updated during the learning stage, not just the winner. The Kohonen learning comprises two stages: in the first phase the input space should be covered and overall neighborhood relations be created, the second phase should integrate the details into the model and secure the convergence of the algorithm. These goals can be achieved if the learning rule is adaptive in relation to the execution time (number of adaptation rounds) thereof; as presented above, the neighborhood width δₙ decreases with time. The mathematic formulation of applicable function is, for example,

$${δ}_{n} = \frac{1}{a + bn} ,$$

wherein a and b are positive constants and n is the preferred time factor like number of rounds executed. The adaptation rate γ_{K} can be updated correspondingly if seen useful. More data about the Kohonen learning rule and SOM can be found in the reference titled “Self-organizing Maps” mentioned above by Teuvo Kohonen and published in 1995 by Springer-Verlag's Series in Information Sciences, Vol. 30.

3. The update rate is then stored in step 346:

Δω_{c}←Φ_{c}^{T}φ,

wherein Δω_{c} is cth element of the weight update vector Δω comprising total of n elements.

4. Finally in step 348 the contribution of the latent variable index c is eliminated by

φ←φ−Φ_{c}^{T}φ·Φ_{c}.

5. The algorithm is repeated from Step 1 if the number of iterations is still under m, where m is is a scalar value determining how many latent vectors can be simultaneously used for describing a data sample (≦n), see step 349.

D) Adjusting the Mood

The user's mood center location in relation to the category center can thereafter be constructed by calculating an updated weighting vector in step 350 with recursion:

ω_{ν}(mood)←(1−γ_{ω})ω_{ν}(mood)+γ_{ω}Δω.

E) Maintaining Sparsity

Entry frequencies (“relevancies”) need to be updated, step 352:

ρ_{ν}=Γ(λ_{T}ρ_{ν}+|ƒ|).

In above equation, the cut function Γ is used to set the least significant vector elements to zero, and λ_{T} is a weighting constant. The entries that are dropped by the cut function, are also dropped in the vector θ_{ν}.

F) The Personal “Mood Center” is Constructed, and the Method Flow Returns to Step 334 of FIG. 3A:

$${f}_{v} ( mood ) = {f}_{v} + {\sum }_{i = 1}^{n} {{ω}_{v} ( mood )}_{i} \cdot {φ}_{i}$$

wherein weighting factors for the corresponding category weight the latent vectors 1-n thus specifying with the category center in question the actual “absolute” location of the current “mood” center. Notice that as the user-specific demographic features cannot be adapted (at least automatically as a result of simple hate or love type feedback) they are masked (left) out from the latent vectors Φᵢ for the time of calculating the above equation.

The error between a data entity, in this particular embodiment a piece of music, and the mood center tells about how well the entity matches with the user's mood. It can be calculated by

e=ƒ_{ν}(mood)−ƒ,

and the distance from the mood center correspondingly

\sqrt{e^{T}e.}

The piece of music (in other services whatever type of data preferred) that is located nearest to the mood center is the one to be selected by the selector if additional special conditions do not exist.

The convergent latent vectors give information about the relationships between different vector entries; especially as the users' demographic information is included in the data used for model adaptation, there will be information available about what type of listeners listen to different music. The advertisers may exploit this knowledge, for example.

The global latent vectors give information about the behaviour of a larger group of people—that is, some kind of collaborative filtering is achieved for free. As the latent vectors are adapted because of the other listeners' actions, the passive listeners will also benefit due to the automatically updated vectors. One may ask how can it be certain that the models do not get blurred because of the unsupervised adaptation? The reasoning is grounded on the basic assumption of global moods: further adaptation of convergent latent vectors does not ruin the existing organization between them.

One more application for the presented modeling technique is based on the idea that various people may utilize it and compare their listening habits with each other. For example, different famous users' models can even be made downloadable from the server by others willing to experience what it feels like to be a renowned person.

In practice, the system implementing the proposed modelling technique may comprise a client entity for gathering/forwarding feedback and receiving personalized data from a server entity that constructs the average and user-specific models on the basis of the feedback, maintains a service data storage, and provides the data stream to the users, as shown in FIG. 1. In addition, the functionality required for executing the proposed method can be constructed in many alternative ways. For example, all the data analysis, model construction and even data storing may be performed by the client entity of a single user if it is informed about other user's situation; if at least weight update vectors Δω (and possibly adaptation parameters like neighborhood width) are transferred between the client entities (a server may maintain a list of users whatsoever) the global model may be updated independently in every client entity and the server load remains insignificant.

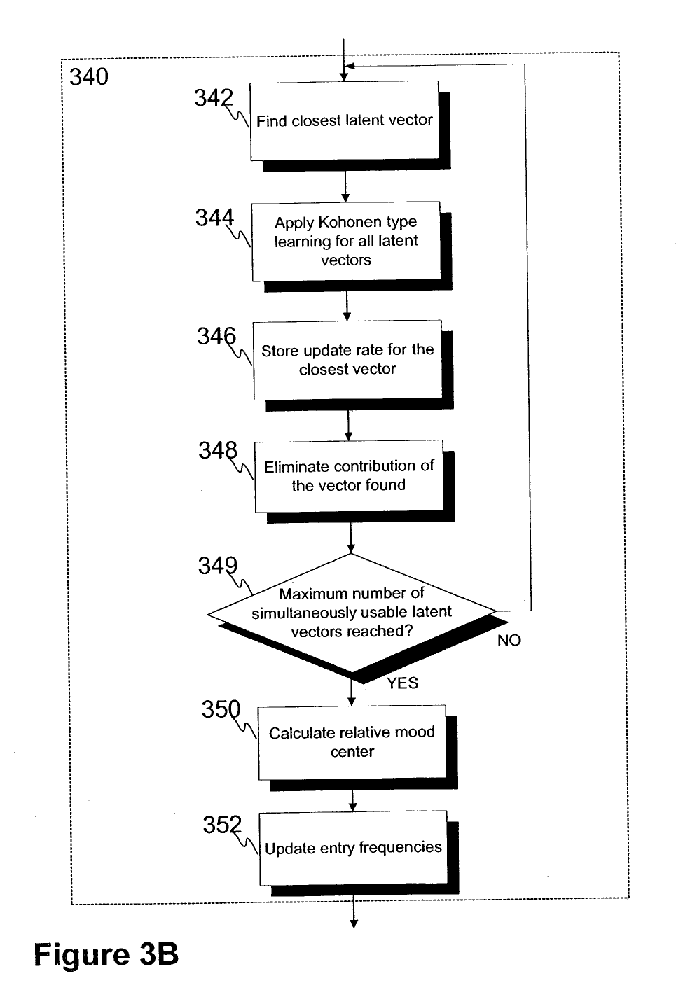

FIG. 4 depicts one option for basic components of a device like a pc, PDA or advanced mobile terminal such as a GSM (Global System for Mobile Communications) or UMTS (Universal Mobile Telecommunication System) cellular phone, capable of transferring, processing and storing data, acting as an element (client/server) of the invention. A memory 402, divided between one or more physical memory chips, comprises necessary code 416, e.g. in a form of a computer program/application, and data 414, e.g. actual data elements (e.g. pieces of music in the case of a net radio) and feature vectors representing them, for the proposed method. A processing unit 406 is required for the execution of the method including the analysis and model reconstruction in accordance with instructions 416 stored in the memory 402. A display 404 and a user interface 412 are typically needed for providing necessary device control and data visualization means to the user. The user interface 412 may also be applied to gather the necessary feedback for model adaptation. Data transfer means 408, e.g. a radio frequency transceiver in the case of a mobile terminal or a fixed wire connection interface like an Ethernet adapter in a standard pc computer, is required for handling data exchange with other devices (client 116/server 102). In the particular example of net radio, audio parts 410 include e.g. transducers and amplifiers necessary for interfacing (at least outputting) acoustic signals such as speech and music with said device. In a system of the invention comprising one or more client devices 116 and at least one server device 102, both the device types include processing unit 406, memory 402, and data transfer means 408 in order to handle the minimum tasks required for the method execution. However, for example in the server 102, it is not necessary to have display 404, user interface 412, or audio parts 410 attached all the time if the server 102 normally operates autonomously without manual intervention by the administrator.

As shown in FIG. 2, the radio program includes many other categories in addition to just music; the selector is arranged to determine the schedule of different program types (music, news, ad, promo), whereas the selection of the actual piece of news/ads/promo may be carried out by the user's category-specific static model: there may be different personalities reading the news etc. When program featuring and presented modeling method is extended from music to news, ads and promos, some of the above features defined for music may be applicable as such, for example, “mode”—if somebody wants happy music, he may also want amusing news and ads. Energy, tempo, and texture can also be considered universal. Additional parameters can be added as well, e.g. theme (sports, politics, violence, free time, environment) and title (Kursk, some earthquake, strike, etc).

The scope of the invention can be found in the following claims. However, utilized devices, method steps, data structures etc may vary significantly depending on the current scenario, still converging to the basic ideas of this invention. For example, it is clear that the invention may be exploited in any kind of electronic device that bears necessary capabilities for performing the required actions. The invention can even be completely executed in a single device without data exchange with a server or other devices, if the single device comprises data storage with all the data elements that should be found in the data space. In that case other users' actions do not naturally affect the model parameters and therefore the latent vector adaptation is slower and collaborative filtering is not achieved, but at least personal preferences can still be recorded and taken into use. The concepts of user preferences and user feedback are diverse. In a conventional case the user is a human person who, by pressing a button or by giving e.g. voice commands, submits his feedback to the modeling system for further analysis. It must be noted though, that the user can as well be e.g. another computer application from the modeling system's standpoint as long as the application is functionally connected to the modeling system and all essential control data including feedback is properly supplied thereto for updating the model and at least for providing a right type of data to the user. Then neither the preferences nor the feedback are necessarily anyone's personal but obtained more like through mathematic processing, if, for example, the application puts data from the modeling system forward and analyses via sensors if the environment reacts to the outputted data in a positive or negative way; this can be tested via a multiple of conditions the output of which constitute the feedback for the modeling system.

Furthermore, the presented embodiment defines steps for carrying out the invention in an exact manner but the inventive idea as such is not limited to any certain implementation. For instance, techniques for latent and weighting vector generation may be varied depending on the system resources, available algorithms, free memory etc. Finally, utilized parameters and e.g. data fields in the vectors are not limited to the ones of the disclosed embodiment. Some of the weighting factors or part of the demographic information may be removed or more to be added if seen purposeful.

1. A method for modeling user preferences in a multi-dimensional data space wherein data entities are presented as vectors, elements of which are characteristic of features thereof, said data entities clustered into a number of categories, a set of latent vectors specifying directions in said data space, said method comprising the steps of
defining an initial set of latent vectors (322),
defining an initial category center for each category of data (324),
obtaining feedback concerning a data entity related to one of said categories (326),
adjusting the category center of said category according to said obtained feedback (328),
adjusting said latent vectors according to said obtained feedback (330), and
adjusting a set of weighting factors according to said obtained feedback in order to weight a set of latent vectors with said adjusted weighting factors in order to determine present preferences of a user in relation to said data space (332).

2. The method of claim 1, further comprising the step of calculating a mood center of the user by utilizing said set of weighted latent vectors and the category center of said category (334).

3. The method of claim 1, wherein said adjusting of the category center includes calculation of a difference between a category center vector and a data entity vector.

4. The method of claim 1, wherein said set of latent vectors is established by an iterative process including a step of selecting a latent vector matching best with a target vector, said target vector being calculated according to said obtained feedback and best-matching latent vectors previously found during the iterative process.

5. The method of claim 1, wherein said latent vectors are adjusted by utilizing substantially a learning rule of Kohonen.

6. The method of claim 1, wherein said latent vectors are common to the users.

7. The method of claim 1, wherein said weighting factors are at least one of the following: category specific, user specific.

8. The method of claim 1, wherein said feedback obtained from the user indicates substantially either like or dislike of the data entity.

9. A computer program for storage in a computer readable medium comprising code for performing the steps of the method of claim 1 when said program is run on a computer.

10. The computer readable medium of claim 9 carrying said computer program.

11. A system comprising processing means (406) and memory means (402) for modeling user preferences in a multi-dimensional data space wherein data entities are presented as vectors, elements of which are characteristic of features thereof, said data entities being clustered into a number of categories, a set of latent vectors specifying directions in said data space, said system further comprising means for obtaining feedback (408) concerning a data entity related to one of said categories;
said system arranged to define an initial set of latent vectors and an initial category center for each category of data, to adjust the category center of said category according to said obtained feedback, to adjust the latent vectors according to said obtained feedback, and to adjust a set of weighting factors according to said obtained feedback in order to weight a set of latent vectors with said adjusted weighting factors in order to determine present preferences of a user relative to said data space.

12. The system of method 11, further arranged to calculate a mood center of the user by utilizing said set of weighted latent vectors and the category center of said category.

13. A server comprising processing means (406) and memory means (402) for modeling user preferences in a multi-dimensional data space wherein data entities are presented as vectors, elements of which are characteristic of features thereof, said data entities clustered into a number of categories, a set of latent vectors specifying directions in said data space, said server further comprising data transfer means for receiving feedback (408) concerning a data entity related to one of said categories;
said server arranged to define an initial set of latent vectors and an initial category center for each category of data, to adjust the category center of said category according to said obtained feedback, to adjust the latent vectors according to said obtained feedback, and to adjust a set of weighting factors according to said obtained feedback in order to weight a set of latent vectors with said adjusted weighting factors in order to determine present preferences of a user relative to said data space.

14. The server of claim 13, further arranged to calculate a mood center of the user by utilizing said set of weighted latent vectors and the category center of said category.

15. An electronic device for interfacing a user with a server capable of modeling user preferences in a multi-dimensional data space wherein data entities are presented as vectors, elements of which are characteristic features thereof, said data entities clustered into a number of categories, a set of latent vectors specifying directions in said data space, said device comprising processing means (406) and memory means (402) for processing and storing data, user interface (404) for receiving feedback, and data transfer means (408) for sending said feedback or a derivative thereof to the server and for receiving data from the server, the data received selected by the server in accordance with the feedback sent, said feedback concerning a data entity related to one of said categories and affecting at least one of the following user preference model parameters in the server: category center, latent vector, weighting factor for latent vector.

16. The electronic device of claim 15, further arranged to receive a category selection request from the user via the user interface (404) and send it or a derivative thereof (408) to the server, said request indicating the category from which the data is to be received next.

17. The electronic device of claim 15, which is substantially a personal computer, a personal digital assistant (PDA) or a mobile terminal.
